(19) United States
(12) Patent Application Publication
(10) Pub. No.: US 2005/0148456 A1
(43) Pub. Date: Jul. 7, 2005

(54) Off-site regeneration of reforming catalysts

(76) Inventors: Pierre Dufresne, Valence (FR); Pauline Galliou, Chanas (FR); Jean Denis Bergougnou, Loriol (FR); Gerard Lenain, Montmeyran (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/993,149

(22) Filed: Nov. 22, 2004

Related U.S. Application Data
(60) Provisional application No. 60/523,314, filed on Nov. 20, 2003.

(30) Foreign Application Priority Data
Nov. 20, 2003 (FR) 03/13.594

(51) Int. Cl. B01J 38/44

(52) U.S. Cl. 502/37

(57) ABSTRACT

The invention relates to a process for regenerating catalysts for conversion of hydrocarbons, the catalyst generally comprising at least one precious metal, preferably a group VIII metal from the periodic table of the elements, optionally at least one additional metal, at least one halogen and at least one porous substrate, the process according to the invention having at least one combustion step for the spent catalyst and at least one oxyhalogenation step, these steps being performed in a same, single regeneration zone in which the catalyst to be regenerated is located in the form of a fluidized bed.

This application claims the benefit of U.S. provisional application, Ser. No. 60/523,314 filed Nov. 20, 2003 under 35 USC 119(a).

This invention relates to a process of regenerating catalysts from hydroconversion of hydrocarbons and preferably from catalytic reforming. The catalyst generally comprises at least one metal that can be a metal from group VIII of the periodic table of the elements, notably a noble metal of this group VIII, or another precious metal such as silver or gold. Platinum is preferably used. The catalyst optionally contains at least one additional metal selected from the group formed by the metals from groups 7, 8, 9, 10, 13, and 14 of the periodic table of the elements, and copper; it further contains at least one halogen, preferably chlorine, and at least one porous substrate, amorphous or crystalline, preferably amorphous and with an alumina base. The reforming catalysts the most often used contain platinum, associated with either tin or rhenium, deposited on a gamma-type alumina. In certain cases, catalysts containing platinum deposited on a zeolite can be found.

The process of catalytic reforming is a process used very widely by refiners to upgrade the heavy naphtha obtained by distillation, with a low octane index. The chemical transformation of the heavy naphtha feedstock comprising mainly hydrocarbons containing 7-10 carbon atoms per molecule consists mainly in the transformation of n-paraffins and of naphthenes contained in the aromatic hydrocarbon feedstock, by reactions of which the most studied are strongly endothermic. Said transformation, called catalytic reforming, is generally obtained at high temperature (on the order of 500° C.), at average low pressure (3.5 to 25.10⁵ Pa) and in the presence of a catalyst. It produces a reformate, a gas rich in hydrogen, combustible gas (C₁−C₂) and liquefied gases (C₃+C₄) as well as coke.

The reforming catalyst is generally a porous solid in the form of small rods (extruded), balls, or grains, and comprises alumina, chlorine, platinum and an additional metal selected from the group formed by metals of groups 7, 8, 9, 10, 13, and 14 from the periodic table of the elements, and copper, such as thallium, manganese, germanium, indium, iridium, rhenium, or tin, preferably rhenium or tin. The reforming catalyst is a highly formulated product whose cost is very high because of the use of precious metal(s).

During the catalytic reforming process, the catalyst activity is reduced progressively mainly by deposit of coke on the surface. Thus it is necessary periodically to go to a regeneration operation that comprises mainly the elimination of coke by controlled burning, generally in the presence of air diluted by nitrogen (an operation called hereafter coke combustion) and oxychlorination, which makes it possibly mainly to redisperse the metals but also to adjust the acidity of the alumina by adding, in an oxidizing environment, chlorine or a chlorinated organic compound (an operation hereafter called oxychlorination).

The conventional operation for regeneration of the reforming catalyst takes place in-situ, i.e., at the refinery site (on-site), and it is conducted differently depending on the catalytic reforming process used.

If the catalytic reforming process is a continuous-type process or CCR, i.e., Continuous Catalytic Reforming, the catalyst flows progressively (circulating bed) in reaction zones in which the feedstock flows and where chemical reactions associated with catalytic reforming take place, then it is withdrawn from the last reaction zone to be conveyed to a regeneration zone (such as in U.S. Pat. No. 5,034,117).

The duration of one cycle (reaction+regeneration) for the catalyst is generally between 0.1 and 10 days. In the regeneration zone, the catalyst is first of all generally stored in an accumulation reservoir and then brought to the regeneration zone itself, where it proceeds to the combustion of coke, then to oxychlorination. The catalyst is reconveyed to the first reaction zone, generally after passing through an accumulation reservoir, after a reduction operation that makes it possible to put the catalyst into a state where it will be active for the reforming reaction and optionally a sulfurization operation that corresponds to a passivation, by the sulfur, of the additional metal used, an operation that takes place depending on the nature of said metal (this sulfurization is used, for example, for rhenium but not for tin). But said reduction operation, and said optional sulfurization operation, can also take place in the first reaction zone. Finally, in this case, the catalyst is regenerated in a zone separate from the reaction zones but in direct contact with them.

If the reforming process is a process of the semi-regenerative type (also called fixed bed), the catalyst is present in the reaction zones in which the feedstock circulates, but the catalyst does not circulate from one reaction zone to another while the chemical reactions associated with catalyst reforming are taking place. In this case, regeneration is periodically performed, generally for 7 to 10 or 15 days every 3 to 12 months of use, depending on the severity of operations. The catalyst stays in the reaction zone, which becomes the regeneration zone. In certain types of processes comprising several reaction zones, it is also possible to isolate one reaction zone from other reaction zones, so that it serves as regeneration zone while the other reaction zones continue to perform catalytic reforming, but then only a part of the catalyst present in all the reaction zones is regenerated. Thus, in this case, the catalyst is regenerated in a zone that is also a reaction zone.

There are also cases where the catalytic reforming process is a mixed technology process, i.e., a single process associates reaction zones using semi-regenerative technology and reaction zones using continuous technology. In this case, the two types of regeneration are used.

These catalytic reforming processes, conventional and widely used in refineries, have drawbacks during operation, due mainly to the lack of flexibility in the regeneration systems used.

Indeed, regeneration in a CCR-type process is directly up against what happens in the reaction zones, and any abnormal operation of said zones has direct repercussion on the operation of the regeneration zone, because the regeneration zone is generally programmed to operate only under conditions of normal usage. Thus any malfunction that translates into an elevated coke content in the catalyst to be regenerated, with respect to the content during normal operation, which is generally 4-5% by weight of coke, requires slowing the regeneration speed of the catalyst to prevent significant exothermicity problems in the regeneration zone, which translates overall into a lowering of the feedstock throughput and thus a lowering of the unit's production, which costs the refiner dearly; or into totally changing the catalyst and sending the spent catalyst (if it is not reusable) to a company that recovers platinum. Moreover, the combustion of the coke can be incomplete.

As for regeneration in a process of the semi-regenerative type, it requires stopping the production unit during the entire regeneration period, which costs the refiner dearly, and this, the longer a malfunction in the reaction zones will have led to a coke content that is higher than during normal operation.

Further, regenerations in such catalytic reforming processes also pose technical problems. Thus such regenerations involve the use of air diluted by nitrogen (with oxygen content from 0.1 to 1% by volume) to burn the coke, in particular when the combustion gas throughputs are high, and the injection of a chlorinated compound during said step, which poses problems with respect to the environment. Further, regenerations performed according to the prior art in continuous type processes (CCR) or in the semi-regenerative type do not make it possible to assure, with certainty, a perfect homogeneity in combustion or oxychlorination treatment for all the catalyst particles. Finally, such catalytic reforming processes comprising on-site regeneration do not make it possible to assess the quality of the totality of the catalyst because any sample of the catalyst taken from the unit (during production and regeneration) is localized and not representative of the overall catalytic mass. For example, incomplete coke combustion throughout the catalytic mass would not be seen in one sampling of the catalyst. Therefore catalytic reforming processes require, more particularly than other refining and petrochemical processes, permanent, and as exact as possible, a surveillance of the catalyst. Further, in the prior art, there are essentially two types of implementation for regeneration. In certain techniques, regeneration is performed in moving bed, the catalyst circulating through the separate zones for coke combustion and oxyhalogenation. In other techniques, regeneration is performed in a single, fixed bed, each regeneration step being performed in this bed.

The processes of off-site catalyst regeneration exist in refining for spent catalysts coming from hydrotreatment. They comprise mainly a step of stripping residual hydrocarbons, and a step of combustion of sulfur and carbon. But they do not comprise an oxyhalogenation step. Hydrotreatment catalysts, which generally do not comprise a precious metal, thus do not undergo the same regeneration treatments as catalytic reforming catalysts.

It has been sought advantageously to improve off-site regeneration and thus to be able to propose methods of off-site regeneration of spent catalysts from catalytic reforming leading to technical results that are at least as good and often better than conventional on-site regeneration processes for catalysts from catalytic reforming that are currently used.

Another object of the invention is to be able to propose off-site regeneration methods for any spent catalyst from hydrocarbon treatment comprising at least one precious metal, preferably platinum, and for which the regeneration must comprise at least one coke combustion step and one oxyhalogenation step, preferably oxychlorination, to redisperse said precious metal. The regeneration treatment according to the invention makes it possible to eliminate most of the coke deposited on the substrate and to redisperse the metallic phase.

The invention thus relates to a process for regeneration of a spent catalyst from treatment of hydrocarbons, preferably from reforming, comprising at least one metal from group VIII from the periodic table of the elements, notably a noble metal from the platinum family (palladium, platinum, iridium, osmium, ruthenium, rhodium) or any precious metal such as silver and gold, optionally at least one additional metal selected from the group formed by metals from groups 7, 8, 9, 10, 13, and 14 from the periodic table of the elements and copper, optionally and preferably at least one halogen, preferably chlorine and at least one porous substrate, preferably alumina. Platinum is the preferred metal, optionally accompanied by an additional metal, rhenium or tin.

Patent EP-B-710502 from the applicant describes an off-site regeneration process that comprises at least the two following successive steps:

at least one step for combustion of the coke present on said catalyst in the presence of a gas comprising oxygen, at a temperature between 300 and 680° C., preferably between 350 and 550° C., still more preferably between 350 and 470° C., for a period between 0.3 and 7 hours,

at least one oxyhalogenation step, preferably oxychlorination, in a controlled air atmosphere, at a temperature between 300 and 650° C., preferably between 350 and 550° C., for a period between 0.3 and 3 hours and in the presence of a halogenated compound, said process is performed off-site and a furnace selected from among moving bed furnaces, i.e., in movement, is used for step (1) of combustion and step (2) of oxyhalogenation.

Among moving bed furnaces, there are stirred bed furnaces, shaking bed furnaces (i.e., made of a thin layer, whether the reactor is cylindrical or radial), fluidized bed furnaces or other furnaces such as circulating bed furnaces. For example, furnaces of the rotolouver type can be used (i.e., of the moving type, stirred and made of a thin layer) or belt-type furnaces (i.e., made of a thin layer and moving).

In this patent, the catalyst moves from the zone where the combustion step takes place to the zone for oxyhalogenation.

The process according to the invention is a multistep process of regeneration using a single reactor or a single fluidized bed furnace (or, more generally, a moving bed, even if below we speak conventionally of a “fluidized” bed). The spent catalyst is introduced into this reactor and there undergoes successively all the following steps:

(1) optionally stripping under air, nitrogen, or a mixture of these two gases (said stripping can also take place outside this reactor),

(2) progressive combustion of coke: this step (2) is a step for combustion of the coke present on said catalyst in the presence of a gas comprising molecular oxygen, for example air optionally diluted by nitrogen, at a temperature generally between 300 and 680° C., preferably between 350 and 550° C., for a period between 0.5 and 10 hours. Preferably, step 2 is performed at variable temperature, low at the beginning (250-450° C.) under air (optionally diluted with nitrogen), then higher in the final stage (500-550° C.),

(3) oxyhalogenation and notably oxychlorination of the catalyst to be regenerated. It will be noted that the two steps of combustion and oxyhalogenation can be performed either in sequence, or simultaneously, or at least partially together, the latter possibility being preferred; in this case thus the oxyhalogenation step is at least partially mixed or entirely mixed with the combustion step. The oxyhalogenation step, optionally at least partially mixed with the end of the preceding step, which is distinguished from the combustion by addition of water and a chlorinated compound to redisperse the metals. The oxyhalogenation step is optionally followed by calcination, consisting of halting the injection of water and the chlorinated compound, while maintaining or increasing the throughput of the oxidizing gas, preferably air,

(4) optional reduction, under pure hydrogen or diluted after purging with nitrogen,

(5) optional sulfurization or passivation (arbitrarily we use the term “sulfurization” below) during the step of cooling under hydrogen, introduction of a sulfurized compound, this step can optionally be partially mixed with the preceding step.

Thus a complete process of regenerating reforming catalysts is involved, off-site or ex-situ, in a moving bed, but where the catalyst does not circulate from one step to the other (said catalyst is called noncirculating); it would circulate “around itself,” while staying confined in the same reactor for the different steps of this treatment. In other words, its average statistical path during the treatment is zero. It is a “batch” process.

The advantages of the new process according to the invention are the following:

batch process making it possible to have flexibility in the steps: certain catalysts contain hydrocarbons, thus are to be stripped in advance, others not,

batch process making it possible to have flexibility in the “length” of the steps, i.e., in the dwell time in each step. Certain catalysts are only 5% carbon, others 15 or 20%, necessitating management of the exothermic steps of removing the carbon under variable conditions (which a conventional CCR loop does not know how to do, for example),

batch process making it possible to have flexibility in the redispersion steps for platinum. Here again, the dispersion of platinum on the spent catalyst can be variable and necessitate variable dwell times or conditions during oxychlorination,

batch process making it possible to add specific steps if necessary. A catalyst poisoned by sulfur would require a special cycle partially to desulfurize it: an operation sometimes called “shampooing” with hydrogen, which is an alternating, high temperature treatment, partly under hydrogen and partly under oxygen and optionally a halogen, to desorb part of the sulfur,

possibility of isolating and thus characterizing “sublots” from the total batch, useful for quality control and traceability of these heterogeneous catalysts with precise specifications,

good management of the “surveillance” of the product containing high-value, precious metals in the context of a batch process. The catalyst passes from the storage location to a single reactor, there undergoes the entire regeneration cycle, and returns to storage,

production of fines and dusts confined to a small number of locations, in comparison to a continuous unit comprising several geographically separate steps,

considerably reduced investment,

better gas-solid contact than a rotating furnace with a simple barrel, thus a better result from oxychlorination,

more generally, if certain types of catalysts require specific treatment sequences, this type of process would make it possible to respond with great flexibility.

The process according to the invention is particularly well suited for treatment of spent catalysts containing platinum such as those coming from a process of treating petroleum feedstocks (by reforming), whether this process is of the fixed or moving bed type.

The regeneration process according to the invention makes it possible for the refiner to resolve problems posed by on-site regeneration of the prior art. In particular, said process makes it possible better to control the two principal steps of regenerating a catalyst, comprising at least one precious metal, preferably platinum, which are the steps of coke combustion and oxychlorination. Further, the regeneration process according to the invention makes possible manipulation external to the reaction site of the catalyst comprising at least one precious metal. This would not be envisaged by one skilled in the art up to now, mainly because manipulation of a very costly catalyst comprising at least one precious metal and the off-site oxyhalogenation step, preferably off-site oxychlorination, were obstacles difficult to surmount.

### SUMMARY OF THE INVENTION

The regeneration process according to the invention is performed off-site, i.e., it is performed outside the treatment unit for hydrocarbons, preferably for catalytic reforming, and more generally outside the site of the refinery. The catalyst is removed from the reaction zones of the refinery, then regenerated before returning to said zones.

Optional step (1) of the process, stripping, is useful when the catalyst contains hydrocarbons adsorbed into its porosity. The latter must be eliminated before driving the catalyst to a high temperature in an oxidizing atmosphere. This stripping is performed, according to this invention, either under air or under nitrogen, or a mixture of these two gases.

Step 2 consists in progressively burning the carbon and the hydrogen, constituents of coke, at variable temperature, and more particularly, as indicated above, low at the beginning (250-450° C.) under air (optionally diluted with nitrogen), then higher in the final stage (500-550° C.). This last step is integrated with step (3), called oxychlorination, or redispersion of the metallic phase. This step can optionally be followed by calcination, consisting in halting the injection of water and of chlorinated compound, while maintaining or increasing the throughput of the oxidizing gas, preferably air. Then optionally other treatment steps can follow, variable depending on the type of catalyst used. Thus it is often desirable, to obtain afterward an activated catalyst that is ready for use in the catalytic unit, to proceed to a step (4) of reduction. It is performed under hydrogen that is pure or diluted after an indispensable purge of nitrogen from the reactor, at a temperature generally between 200 and 700° C., and preferably between 400 and 550° C. Finally, the catalyst can require a last step, step (5), which was arbitrarily called “sulfurization” above. Thus, this can be a “fine tuning,” for example a passivation, or a selectivization by adding a molecule containing sulfur. This is necessary for certain catalysts, notably those that contain rhenium associated with platinum, rhenium having properties tending toward hydrogenolysis, which can be destroyed by selective sulfurization. This step is performed in the presence of a gas preferably containing hydrogen in the presence of a sulfured compound. The latter is selected from the group comprising sulfurs (mono, di, or polysulfurs), hydrogen sulfide, the mercaptans, thiophenic compounds, and any other compound containing sulfur and able to decompose in H₂S under hydrogen pressure. This step can be partially integrated with the preceding step, because it can be performed during the step of cooling under hydrogen. The optional off-site sulfurization step is a conventional treatment step and a sulfured compound.

The process according to the invention can thus comprise a reduction step followed by a step of sulfurization of the catalyst. But said steps can also be performed at the site of the refinery, i.e., at it, generally in the hydrocarbon treatment unit, for example for catalytic reforming.

### DETAILED DESCRIPTION

The catalyst regenerated according to the process of the invention is a catalyst comprising at least one precious metal selected from the group formed by silver, gold, ruthenium, rhodium, palladium, osmium, iridium, and platinum, preferably platinum, optionally and preferably at least one halogen, preferably chlorine (generally the content is between 0 and 3% by weight, preferably between 0.5 and 1.1% by weight of chlorine in the case of a spent catalyst from catalytic reforming) and at least one porous substrate selected from among substrates of the types alumina, silica, zeolite or coal, preferably said catalyst is a catalytic reforming catalyst. In the case of a catalytic reforming catalyst, the catalyst regenerated according to the invention is a porous solid generally in the form of small rods (extruded), balls or grains, which most often consist of alumina, chlorine, platinum and at least one additional metal. The additional metal is generally selected from the group formed by the metals of groups 7, 8, 9, 10, 13, and 14 from the periodic table of the elements and copper, such as thallium, manganese, germanium, indium, iridium, rhenium, or tin, preferably rhenium, iridium, or tin.

The preparation of the catalyst regenerated according to the invention is conventional. In the case preferred, according to the invention, of a reforming catalyst, it generally comprises fixation of the metals on the substrate during impregnation: the ionic precursor, soluble in water, is exchanged at the surface of the substrate: the catalyst is then centrifuged, filtered, and dried; then it undergoes calcination under air sweeping at a temperature generally slightly higher than 500° C. After calcination, the catalyst must again be reduced to be ready for use. This operation is performed at high temperature under hydrogen pressure. Finally, before being put in contact with the hydrocarbons, it is generally necessary to reduce the hydrogenolysis activity of the small metallic particles by injecting a sulfurized compound: this is the optional step of sulfurization of the catalyst, which is used especially if the additional metal is rhenium or iridium.

The spent catalyst, i.e., which must be regenerated, generally comprises at least 1% by weight of carbon, preferably between 3 and 20% by weight. In the case preferred, according to the invention, of a spent catalyst from catalytic reforming, its chlorine content is generally between 0.5 and 1. 1% by weight.

According to this invention, step (1) is a step of stripping hydrocarbons. It is optional insofar as the spent catalysts do not contain all of the free hydrocarbons. It is performed in the reactor in a batch under nitrogen, under diluted air, or under pure air. If the treatment gas is nitrogen, the operation is endothermic, and it will be able to be performed in a mode where the bed is not fluidized. Preferably, operation with a high throughput of gas containing oxygen, thus a fluid bed, will nevertheless be chosen, so that the temperature of the bed can be made to rise as quickly as possible. The operation is thus integrated with step (2) of carbon combustion, this step being able to be quasi-transparent during the phase of rising temperature in oxidizing atmosphere. The content of hydrocarbons in the exiting gases must be sufficiently low so that it is below the limits of explosivity.

According to this invention, step (2) is thus a step for combustion of the coke present on said catalyst in the presence of a gas comprising oxygen, at a temperature between 300 and 680° C., preferably between 350 and 550° C., for a period between 0.5 and 10 hours. In the scope of the regeneration process according to the invention, this step (2) for coke combustion is performed in a fluidized (or moving) bed furnace. The gas used in the combustion step is either a mixture of air and nitrogen, or pure air. In any case, the parameter to be followed with very great vigilance is the temperature, the coke combustion reaction obviously being very exothermic. Such a fluidized bed furnace makes it possible to use a high throughput of gas, and thus to well evacuate the heat produced. On the other hand, in the preferred case of catalysts from catalytic reforming, an important parameter also to be monitored is the chlorine content of the catalyst. The chlorine content of the spent catalyst, before elimination of carbon, is often about 1%. The trick to elimination of carbon is to prevent this content from falling to too low a level, for example, below 0.5% by weight. A significant condition is to use a dry gas (air, for example). The humidity characteristic of this gas can be expressed by the dewpoint; the latter is preferably less than 10° C., more preferably 0° C. It is important that the catalyst not be exposed to high concentrations of CO/CO₂ or of H₂O produced from the combustion reaction, as is the case with in-situ regeneration processes. A fluid bed furnace makes it possible to inject large throughputs of dry gas, which limits the concentrations of these compounds, detrimental to the quality of the product. Finally, the hot points and the preferential paths of the gas are reduced.

According to this invention, step (3) is an oxyhalogenation step. It is easily integrated into step (2) because the catalyst remains in the same reactor. It consists in adding water and a chlorinated compound, with oxidizing gas, making it possible to destroy metallic aggregates and their transformation into anions dispersed on the surface of the substrate. The controlled atmosphere of the gas used, notably air, generally comprises preferably 0.1 to 1% (by volume) of water, at a temperature between 300 and 650° C., preferably between 350 and 550° C., and a halogenated compound, preferably a chlorinated compound, a compound comprising preferably between 1 and 6 carbon atoms and 1 to 6 chlorine atoms per molecule such as carbon tetrachloride CCL₄ or dichloropropane C₃H₄Cl₂. The final content of halogenic catalyst is higher than 0.2% by weight and notably between 0.8 and 1.9%, and generally, in the preferred case of reforming catalysts where this halogen is chlorine, must be between 0.9 and 1.2% by weight, preferably between 1.0 and 1.1% by weight. The duration of this step 3, by way of example, can be between 0.3 and 7 hours.

The use of such a type of fluid bed or fluidized bed furnace, for all the regeneration steps, makes it possible to improve the homogeneity of the treatment of the catalyst, avoiding, for example, the formation of preferential paths of the treating gas. Further, said step (3) of oxyhalogenation, preferably oxychlorination, can be performed with great flexibility of the operating conditions, thus in the preferred case, according to the invention, where the halogen is chlorine, it is possible to operate under over-chlorinating conditions, leading to a chlorine content of the catalyst during said oxychlorination step higher than 1.5% by weight, for example. This overchlorination thus makes it possible to have great efficiency in the redispersion of the metallic phase. This chlorine content being, on the other hand, undesirable on the final catalyst, because it confers overly acidic properties onto the aluminous substrate, it can then be reduced to reach the zone of preferred chlorine content, allowable for reforming catalysts, around 0.9 to 1.2% by weight.

The characteristics of the catalyst coming from step (3) of oxychlorination are generally the following. The coke content of said catalyst is generally less than 1%, preferably less than 0.2% by weight. As indicated above, the chlorine content is generally higher than 0.2% by weight of halogen, and more particularly for a reforming catalyst said content is generally between 0.8 and 1.9% by weight of chlorine, preferably between 0.9 and 1.2% by weight of chlorine and still more preferably between 1.0 and 1. 1% by weight of chlorine. The dispersion of the metallic phase needs to have been considerably increased by the oxyhalogenation treatment, preferably oxychlorination. The dispersion is expressed by a nondimensional value, which is the ratio between the number of atoms of metal accessible at the surface and the number of total atoms, and it is measured by techniques of gas quantified chemisorption, notably chemisorption of oxygen. The specific surface of the catalyst is generally modified little by the oxyhalogenation treatment, preferably oxychlorination. In the case of a reforming catalyst, the specific surface is generally between 50 and 300 m2/g, and more often between 120 and 230m2/g.

### EXAMPLES

The following examples illustrate the invention by comparing the prior art without in any way limiting its scope. They were conducted on the scale of a pilot process.

### Example 1

### Comparison not According to the Invention: Regeneration in a Fixed Bed

A spent catalyst from naphtha reforming with a basis of 0.25% of platinum and 0.25% of rhenium, contains 0.73% by weight of chlorine, 14.5% of carbon and 0.8% of hydrocarbons. The equivalent of 100 g of oxide base is loaded into an adiabatic reactor that has a current of preheated gas running through it. This gas can be nitrogen, air, a mixture of these 2 gases, and can have water vapor or dichloropropane added to it, as will be detailed below.

The catalyst first undergoes a step of desorption of the volatile hydrocarbons or “stripping” (1), then a carbon combustion step (2), coupled with an oxychlorination step (3). One proceeds as follows:

The temperature is brought in 4h to 220° C. with a throughput of 2001/h of nitrogen (stripping step 1). Then one proceeds to steps 2 and 3 of combustion and oxychlorination, which are integrated. Here, the gas takes on the following volumetric composition: dry nitrogen at 0.5% oxygen, 0.8% water, 0.04% chlorine (introduced in the form of dichloropropane, which reacts to form hydrochloric acid HCl). The temperature is brought up to 350° C. in 6 h. A plateau of 1 h is observed, then the oxygen content is brought to 1% during 1 h, then to 3% during 1 h, then to 5% during 1 h. Then the temperature is brought in 1 h to 400° C. under a mixture of 0.5% of 02, where plateaus of 2 h are observed at 0.5, 1.3, 5% of O2. Then 450° C., 490° C. and finally 510° C. with plateaus of 1 h. The oxygen content is then brought to 10% during 4 h. The temperature then is again lowered under this atmosphere during 2 hours to 300° C., then without chlorine and water to 220° C.

The results obtained are summarized in Table 1.

The carbon content is measured by a LECO device, the specific surface area is measured by the BET method. The metallic dispersion, measured by the quantity of oxygen adsorbed after reduction under hydrogen, is expressed in % of metallic surface atoms. The measure of the chlorine content is performed by the conductimetry technique (use of a silver solution, a nitric acid solution at 0.1 N having been used to release chlorine from the catalytic surface) on 10 g of sample.

TABLE 1
Characteristics of the catalyst after carbon combustion and
oxychlorination.

| | Carbon | Chlorine | Sulfur | Specific | Dispersion |
|---|---|---|---|---|---|
| | % by | % by | ppm by | Surface | Of Platinum |
| Treatment | weight | weight | weight | (m2/g) | (%) |
| Steps 1 + 2 + 3 | 0.12 | 1.14 | 42 | 199 | 96 |

In comparison with fresh catalyst, (i.e., with catalyst before its introduction for the first time into the catalytic reforming zone) that would have a chlorine content of 0.85% by weight, a dispersion of 100% and a specific surface of 203 m2/g, the characteristics of the catalyst after oxychlorination are very satisfactory, but the method of fixed bed regeneration is long. It is rather well mastered at the laboratory scale, more difficult to manage industrially, the significant catalyst mass and the uncertainties over the gas distribution not guaranteeing perfect homogeneity of the treatment.

The product coming from this step is then reloaded into the same regeneration reactor to undergo the following steps of reduction (4) and sulfurization (5). About 9 g of catalyst is treated by a throughput of 20 1/h of 50/50 hydrogen/nitrogen mixture, from the ambient temperature at 460° C., with an increase over 6 h and a plateau of 2 h. The temperature is again lowered to 400° C., left at a plateau for 6 h while dimethyl disulfide is introduced at the rate of 0.03 grams/hour. The temperature lowers again for 2 h to the ambient temperature, the reactor is purged of nitrogen, then of air. The analytic results of this 5-step treatment are shown in table 2, except for platinum dispersion. The latter is no longer measured reliably after a sulfurization treatment. They are similar for the two products, except for the sulfur amount.

The results obtained are summarized in Table 2.

TABLE 2
Characteristics of the catalyst after carbon combustion, oxychlorination,
reduction, and sulfurization.

| | Carbon | Chlorine | Sulfur | Specific | Dispersion |
|---|---|---|---|---|---|
| | % by | % by | ppm by | Surface | Of platinum |
| Treatment | weight | weight | weight | (m2/g) | (%) |
| Steps 1 + 2 + 3 | 0.12 | 1.14 | 42 | 199 | 96 |
| Steps 1 + 2 + 3 + | 0.09 | 1.03 | 810 | 201 | — |
| 4 + 5 | | | | | |

### Example 2

### Comparison not According to the Invention: Fixed Bed Regeneration without Intermediate Stop

Example 1 is repeated under analogous conditions. The same catalyst is used and the same sequences of regeneration and oxychlorination are used as those of example 1; but here, at the end of oxychlorination, sequences 4 and 5 of reduction and sulfurization are connected without voiding the reactor of spent catalyst in the same regeneration reactor. The results obtained are summarized in Table 3.

TABLE 3
Characteristics of the catalyst after carbon combustion, oxychlorination,
reduction, and sulfurization performed in a fixed bed in series.

| | Carbon | Chlorine | Sulfur | Specific | Dispersion |
|---|---|---|---|---|---|
| | % by | % by | ppm by | Surface | Of platinum |
| Treatment | weight | weight | weight | (m2/g) | (%) |
| Steps 1 + 2 + 3 + | 0.10 | 1.08 | 760 | 197 | — |
| 4 + 5 | | | | | |

The analyses show that the experiment can be repeated correctly, whether the treatments are performed with an interruption between steps 3 and 4 or directly in series. The quality of this catalyst is satisfactory. The two drawbacks of the method are the long dwell time in the furnace, and the fact that this method in series does not make it possible to take a homogeneous sample in the catalytic bed at the end of step 3 to measure the dispersion.

### Example 3

### Regeneration According to the Invention.

A quantity of 100 g of catalyst identical to the one used in examples 1 and 2 is used to perform an experiment in a fluid bed apparatus, supplied by a gas throughput of 2000 liters/hour, whose composition varies during the treatment sequence. As indicated below, the catalyst first undergoes stripping step (1), then carbon combustion step (2), coupled to oxychlorination step (3). The temperature, controlled by a thermocouple placed in the catalytic bed, is brought in ½ 1h to 220° C. under nitrogen throughput (stripping, step 1). Here, the gas assumes the following volumetric composition: dry nitrogen with 5% oxygen, 0.8% water, 0.04% chlorine. Then combustion and oxychlorination are performed (steps 2 and 3): the temperature is raised up to 350° C. in ½ h. A plateau of ½ h is observed. Then the temperature is brought in ½ h to 400° C. under a mixture of 5% O2, then left for ½ h. Then the same sequence at 450° C., 490° C., and finally 510° C. with plateaus of 1 h. The oxygen content is then brought to 10% during 1 h. The temperature again goes down, under this atmosphere, for ½ h to 300° C., then without chlorine and water to 220° C. The furnace is disconnected from its gas evacuation system and a sample is removed and analyzed: see the first line of table 3 (steps 1+2+3). The catalyst regenerated this way can then be conventionally subjected to reduction, then sulfurization, for example in a fixed bed in any reactor or in the reactor that was just used for steps 1, 2, and 3, but in a fixed, non-fluidized bed. It is done as follows: a 50/50 hydrogen-nitrogen mixture is introduced and the temperature is raised in 3 hours to 460° C. and left for 2 hours at this plateau. The temperature again is brought down to 400° C., left at this plateau for 1 h while dimethyl disulfide is introduced at 0.18 grams/hour. The temperature then lowers in ½ h to the ambient temperature, the reactor is purged of nitrogen, then of air. The results obtained are summarized in Table 3.

TABLE 3
Characteristics of the catalyst after carbon combustion, oxychlorination,
reduction, and sulfurization.

| | Carbon | Chlorine | Sulfur | Specific | Dispersion |
|---|---|---|---|---|---|
| | % by | % by | ppm by | Surface | Of platinum |
| Treatment | weight | weight | weight | (m2/g) | (%) |
| Steps 1 + 2 + 3 | 0.04 | 1.13 | 40 | 203 | 98 |
| Steps 1 + 2 + 3 + | 0.03 | 1.03 | 830 | 201 | — |
| 4 + 5 | | | | | |

### Example 4

### Regeneration According to the Invention without Intermediate Stop.

Example 3 is repeated, but here, at the end of step 3 of oxychlorination, one proceeds directly to a step 4 of reduction of the catalyst, then to a step 5 of sulfurization of the same catalyst. These steps 4 and 5 are performed successively in fluid bed in the same reactor as the one used for steps 1, 2, and 3. Notably, at the end of steps 1, 2, and 3, it is still possible to remove a sample of the catalyst to analyze it and, in this example 4, at the end of these steps 1, 2, and 3, the same results are found as those found in example 3 and shown on the first line of table 4. To perform these steps 4 and 5, the operating conditions given in example 3 are used but in fluid bed and not in fixed bed. More precisely, at the end of step 3 of oxychlorination, and after a ½ h purge under nitrogen, a 50/50 mixture of hydrogen and nitrogen is introduced and the temperature is raised in 3 hours to 460° C. and left for 2 hours at this plateau. The temperature is again brought down to 400° C., left at this plateau for 1 h while dimethyl disulfide is introduced at 0.18 grams/hour. The temperature again is lowered in ½ h to the ambient temperature, the reactor is purged of nitrogen, then of air. After this regeneration and oxychlorination procedure lasting about 20 hours, the intermediate product and the final product are analyzed. An advantage of this technology is this intermediate sampling to characterize the product after oxychlorination, platinum dispersion being the key analysis of the entire sequence, this criteria being the most significant in the application of catalytic reforming. The quality of the product is superior to that of the products obtained in preceding examples 1 and 2 (with superior ease compared to the technique of example 3) where the reduction and sulfurization steps of the catalyst are performed in fixed bed and not in fluid bed. The results obtained are summarized in Table 4.

TABLE 4
Characteristics of the catalyst after carbon combustion, oxychlorination,
reduction, and sulfurization.

| | Carbon | Chlorine | Sulfur | Specific | Dispersion |
|---|---|---|---|---|---|
| | % by | % by | ppm by | Surface | Of platinum |
| Treatment | weight | weight | weight | (m2/g) | (%) |
| Steps 1 + 2 + 3 | 0.06 | 1.08 | 40 | 202 | 97 |
| Steps 1 + 2 + 3 + | 1.02 | 830 | 205 | — | |
| 4 + 5 | 0.04 | | | | |

The overall time, compared to the prior art, was shortened in example 3 and more particularly in example 4 thanks to the large quantity of gas injected, a greater stoichiometry of the reactants, better gas/solid contact, and notably more rapid changing of the temperature. The catalyst is perpetually mobile, thus hot points that manifest themselves in fixed bed are avoided when it is desired to shorten the steps.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever. Also, any preceding examples can be repeated with similar success by substituting the generically or specifically described reactants and/or operating conditions of this invention for those used in such examples.

Throughout the specification and claims, all temperatures are set forth uncorrected in degrees Celsius and, all parts and percentages are by weight, unless otherwise indicated.

The entire disclosures of all applications, patents and publications, cited herein and of corresponding U.S. Provisional Application Ser. No. 60/523,314, filed Nov. 20, 2003, are incorporated by reference herein.

From the foregoing description, one skilled in the art can easily ascertain the essential characteristics of this invention and, without departing from the spirit and scope thereof, can make various changes and modifications of the invention to adapt it to various usages and conditions.

1. A process of regeneration of spent catalysts from hydrocarbon conversion, the catalyst comprising at least one precious metal selected from the group consisting of elements of group VIII, silver, and gold, at least one halogen and at least one porous support, process comprising at least the two following steps:
at least one step for combustion of coke present on said catalyst in the presence of a gas comprising molecular oxygen, at a temperature between 300 and 680° C., for a duration between 0.5 and 10 hours,
at least one oxyhalogenation step, in the presence of a halogenated compound under controlled atmosphere of humid air, at a temperature between 300 and 650° C., these two steps being performed in the same, single regeneration zone in which the catalyst to be regenerated is found in the form of a fluidized bed, not circulating or moving.

2. A process according to claim 1, wherein the steps of combustion and oxyhalogenation are performed separately and successively.

3. A process according to claim 1, wherein the oxyhalogenation step is partially mixed with the end of the combustion step.

4. A process according to claim 1, wherein the step of combustion and oxyhalogenation are performed simultaneously.

5. A process according to claim 1, wherein the spent catalyst is subjected to a stripping step before the coke combustion step.

6. A process according to one of the preceding claims claim 1, wherein the spent catalyst is subjected to progressive combustion by heating to 250-450° C.

7. A process according to claim 1, wherein the catalyst obtained at the end of the oxyhalogenation step is subjected to at least one of the following steps:
calcination
reduction
sulfurization.

8. A process according to claim 1, applied to the regeneration of a reforming catalyst and comprising the following steps:
(1) optional stripping under air, under nitrogen, or a mixture of these two gases,
(2) progressive combustion,
(3) oxychlorination, optionally followed by calcination,
(4) reduction under hydrogen,
(5) optional sulfurization.

9. A process according to claim 8, wherein all the steps are performed in the same reactor.

10. A process according to claim 1, wherein the spent catalyst is subjected to an optional stripping, a combustion step, an oxychlorination step, a reduction step, optionally a sulfurization step, and wherein one proceeds to a shampooing of said catalyst.
